(19) United States
(12) Patent Application Publication
(10) Pub. No.: US 2018/0288013 A1
(43) Pub. Date: Oct. 4, 2018

(54) END-TO-END SECURED COMMUNICATION FOR MOBILE SENSOR IN AN IOT NETWORK

(71) Applicant: COMMISSARIAT A L'ENERGIE ATOMIQUE ET AUX ENERGIES ALTERNATIVES, Paris (FR)

(72) Inventors: Christine HENNEBERT, Grenoble Cedex (FR); Alexandre MACABIES, Grenoble (FR)

(73) Assignee: COMMISSARIAT A L'ENERGIE ATOMIQUE ET AUX ENERGIES ALTERNATIVES, Paris (FR)

(21) Appl. No.: 15/944,103

(22) Filed: Apr. 3, 2018

(30) Foreign Application Priority Data
Apr. 4, 2017 (FR) 17 52881

(51) Int. Cl. H04L 29/06; H04W 12/04; H04W 12/08; H04L 9/08

(52) U.S. Cl. CPC H04L 63/0428; H04W 12/04; H04W 12/08; H04L 67/12; H04L 63/10; H04L 9/0825; H04L 9/0861; H04L 63/062

(57) ABSTRACT

An end-to-end communication method between a mobile sensor and a user, the mobile sensor moving within a WSN network, the WSN network including a plurality of sub-networks connected to the Internet with gateways. When the mobile sensor desires to join a sub-network, it transmits an association request to the gateway of the sub-network which relays it to the server via the Internet. The latter communicates to the mobile sensor and to the gateway a temporary encryption key in an encrypted form. The gateway can then communicate to the mobile sensor the security key of the sub-network, by a message encrypted with the temporary encryption key. The mobile sensor can then securely communicate with the gateway, at the link level, with the security key of the sub-network.

### TECHNICAL FIELD

The subject matter of the present invention relates to the security in the field of the Internet of things (IoT).

### State of the Prior Art

The advance of pervasive low rate radio technologies, adapted to autonomous low-energy consumption objects, has recently allowed the development of the Internet of things (IoT). The IoT enables a user to access information, also called resources, from sensors or actuators, being often remote and with low autonomy. The scheme currently retained consists in virtualising these resources in a gateway or server, connected to the Internet or infrastructure.

The end-to-end security, that is from the user to the resource, is actually ensured between the user and the element virtualising the resource on the one hand and, between the element virtualising the resource and the resource itself on the other hand.

The gateway allows continuous communications between the field of the sensor sub-network and the Internet field, by ensuring interoperability of communication protocols. On the other hand, it does not ensure interoperability of the security protocols, hence there is a discontinuous security at the gateway.

In practice, the gateway harbours different security keys which ensure confidentiality and integrity on the one hand with the final user on the Internet side, and with the sensor network on the other hand. These security keys are provided by a server located in the “Cloud”, that can further have a list of the devices permitted to communicate on the network (white list).

Providing security keys to the gateway is well adapted to cases where the sensors are fixed devices, in other words belong to one and a single sub-network over time. On the other hand, when these sensors are mobile and switch from one sub-network to the other, by successively connecting to different gateways when moving, managing communication securities becomes substantially more complex.

The situation of a sensor moving in a WSN network has been illustrated in FIG. 1. In this Fig., a mobile sensor, 110, moving from one sub-network 120 to another sub-network 130 has been represented. The sub-network 120 (resp. 130) is connected to the Internet via the gateway 125 (resp. 135). The gateway 125 (resp. 135) is itself in communication with a server, 140, called a “cloud” server by a secured IP connection. The access by a user, 150, to the resource of the mobile sensor 110 is made via the server 140 and the gateway, 125.

The WSN can be a ZigBee network or even an LPWAN network (Low Power Wide-Area Network), for example a LoRaWAN network (Long Range LPWAN).

The ZigBee standard offers the possibility to manage communication security at the network layer, also called NTW (ZigBee Network Layer) or the application layer, also called APS (ZigBee Application Sub-Layer). On the other hand, the standard is silent about the management of security at the link layer (IEEE 802.15.4 Physical Layer), a fortiori in a situation of mobility and about the distribution of the secrete security keys.

The LoRaWAN protocol does not further provide for management of security at the link layer (Lora MAC), nor management of the secrete keys.

However, it has been proposed in the paper by R. Miller entitled “LoRa Security Building a secure LoRa solution published in MWR Labs Whitepaper, a procedure for distributing the secrete keys on a LoRa network. In particular, when a sensor (node) wishes to join such a network, it initiates a procedure called an activation procedure or OTAA (Over-The-Air-Activation). It is assumed that each node is equipped with a symmetric single secrete key (AppKey). This procedure consists in exchanging messages between the node and the server via the gateway. It starts with sending a join request comprising a MAC header (MHDR), an identifier of the owner of the sensor (AppEUI), a sensor identifier (DevEUI) as well as a nonce (DevNonce) generated by the sensor. The join request is signed by hashing the join request by means of the secrete key AppKey, this signature acting as a message authentication code or message integrity code (MIC).

The join request thus signed is transmitted to the network server LoRa which verifies the authenticity of the message by means of the AppKey. In case of success, the cloud server replies to the sensor by an accept message (join-accept). To do this, the server generates a new nonce (AppNonce) as well as two secrete keys NwkSKey (Network Session Key) and AppSKey (Application Session Key) corresponding to the network layer and to the application layer respectively. These keys are generated by encrypting, by means of the AppKey key, a data sequence obtained by concatenating a predetermined value, of the nonce generated by the AppNonce server, an identifier of the LoRa network, NetID, and the nonce generated by the sensor, DevNonce. The keys thus generated are transmitted to the sensor.

The accept message includes the AppNonce, the address of the destination device, DevAddr, as well as some physical parameters. The message is also signed by means of the AppKey key. Upon receipt, the sensor decrypts the accept message and verifies the MIC code by means of the AppKey. In case of success, the sensor generates on its own the NwkSKey and AppSKey from the AppNonce value contained in the accept message.

However, the solution recommended in the aforementioned paper by R. Miller is not fully satisfactory. Indeed, the header of a MAC frame (MH DR) on the side of the LoRa network has not to be known beyond the gateway, in particular by the cloud server. The server thus has no possibility in practice to verify the authenticity of the join request. Further, any sensor can be connected to the cloud server through any gateway. Therefore, there is no security ensured at the link level in the sub-network, downstream of the LoRa gateway.

The purpose of the present invention is consequently to provide a method enabling the communication between the sensor of the WSN network and the user to be efficiently secured, in an end-to-end fashion at the link level, including when the sensor is in a mobility situation.

### DISCLOSURE OF THE INVENTION

The present invention is defined by an end-to-end secured communication method between a mobile sensor and a user, the mobile sensor moving within a WSN network, said WSN network comprising at least one sub-network connected to the Internet by means of a gateway, said gateway being connected via the Internet to a server managing said WSN network, in which, when the mobile sensor transmits an association request to the gateway, this relays it to the server and:
the server generates a temporary encryption key and communicates it an encrypted form to the gateway as well as to the sensor;
the gateway transmits to the mobile sensor, a sub-network security key for securing, at the link level, the transmissions within the sub-network, said sub-network security key being transmitted to the mobile sensor in an encrypted form by the temporary encryption key;
said mobile sensor transmits to the gateway an acknowledgment message, encrypted by means of said sub-network security key.

The server advantageously has a white list containing the identifiers of the sensors permitted to be connected via said gateway, associated with their respective security keys, as well as the identifier of said gateway associated with its security key.

The mobile sensor can have an identifier and its own security key, and to form said association request, it generates a nonce, said association request being obtained by concatenating the identifier of the mobile sensor, the nonce thus generated and a signature of the identifier and of the nonce thus concatenated by the security key of the mobile sensor.

Preferably, upon receipt of the association request, the server, after it has verified the request integrity, encrypts the temporary encryption key by means of the security key of the gateway to generate a first message and by means of the security key of the mobile sensor to generate a second message, the first and second messages being respectively transmitted to the gateway and to the mobile sensor at the application layer.

The first message is preferably obtained by concatenating the identifier of the gateway, the identifier of the mobile sensor, the nonce and said temporary encryption key to form a first set of concatenated information, said first set of concatenated information being encrypted by means of the security key of the gateway.

Advantageously, the first set of concatenated information is signed by means of a signature key of the gateway and the signature is concatenated to the first set of concatenated information previously encrypted by means of the security key of the gateway.

The signature key of the gateway can be chosen identical to the security key of the gateway.

The second message is preferably obtained by concatenating the identifier of the gateway, the identifier of the mobile sensor, the nonce and said temporary encryption key to form a second set of concatenated information, said second set of concatenated information being encrypted by means of the security key of the mobile sensor.

Advantageously, the second set of information concatenated is signed by means of a signature key of the mobile sensor and the signature thus obtained is concatenated to the second set of concatenated information previously encrypted by means of the security key of the mobile sensor.

The signature key of the mobile sensor can be chosen identical to the security key of the mobile sensor.

The gateway can further transmit to the sensor a third message containing the sub-network key encrypted by the temporary encryption key, the third message being transmitted at the application level or at the network level.

The third message thereby contains a concatenation of the identifier of the gateway, of the identifier of the mobile sensor, of the nonce and of the sub-network key.

When the server detects that a sensor of the sub-network does not reply any longer to the requests of the server, or at regular time intervals, the server can generate a new temporary encryption key, and transmit it to each sensor belonging to the sub-network in an encrypted form by the security key of this sensor or a session key previously exchanged between the gateway and this sensor.

The server can further transmit to the gateway a renew request for the sub-network key to the gateway, said renew request containing the new temporary encryption key, in an encrypted form by the security key of the gateway.

Finally, when the gateway has received the renew request from the server, this can generate a new sub-network key and broadcast it to the sub-network sensor in the form of an encrypted message by the new temporary encryption key.

### BRIEF DESCRIPTION OF THE DRAWINGS

Further characteristics and advantages of the invention will appear upon reading a preferential embodiment of the invention, making reference to the appended figures in which:

FIG. 1, already described, schematically represents the situation of a sensor moving within a WSN network;

FIG. 2 schematically represents the different protocol layers intervening in a communication between a user and a sensor in the situation of FIG. 1;

FIG. 3 schematically represents the distribution of secrete keys in an end-to-end secured communication method according to one embodiment of the invention;

FIG. 4 schematically represents a secured association process of a sensor in an end-to-end secured communication method according to one embodiment of the invention;

FIG. 5 schematically represents a process for renewing/revoking the link key in an end-to-end secured communication method according to one embodiment of the invention.

### DETAILED DISCLOSURE OF PARTICULAR EMBODIMENTS

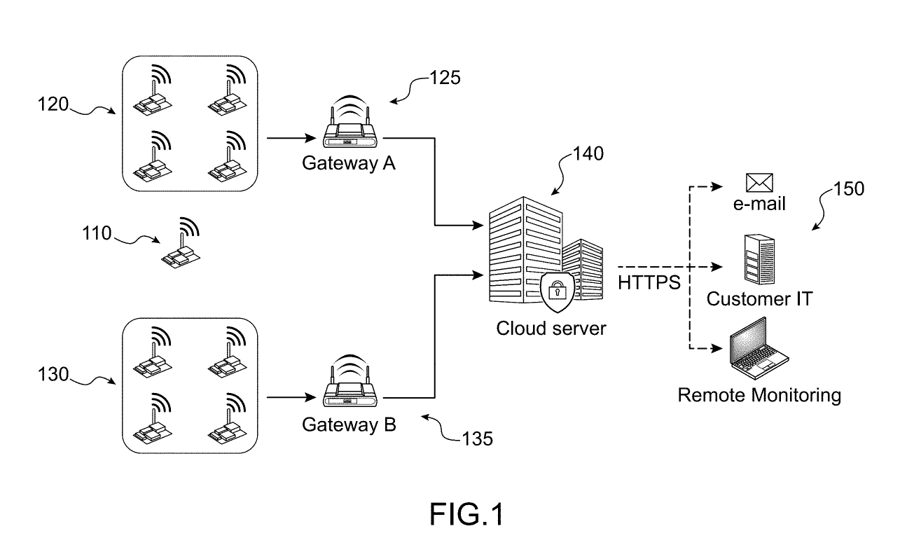

A WSN network is again considered, that is a network of multi-hop wireless sensors as represented in FIG. 1. This network obeys a standard of the Internet of things or IoT, it can be for example a ZigBee network, a 6LoWPAN network or even a LoRaWAN network. This network comprises a plurality of sub-networks, each sub-network being connected to the Internet by means of a gateway, each gateway being connected to the server (cloud server) managing the network.

The sensors of the WSN network accommodate an operating system, such as Contiki (version 3.x), enabling security keys to be managed at the link layer (MAC layer) of the OSI model. Each gateway ensures interoperability of the communication protocols between the WSN network and the Internet. It also accommodates an operating system enabling security keys to be managed at the link level, such as for example a Linux kernel (version 4.4) to securely communicate with the sensor network. The final user accesses the resources provided by the sensors via the Internet.

It is assumed that each sensor of the WSN network is equipped with a security key (for example a 128-bit symmetric key) stored in a read only memory of the FLASH, ROM or EPROM, secured if possible. In the following, AppK_{U} will designate the security key belonging to the sensor having Dev_{U} as an identifier. The security key is a secrete key in that it is only known from the sensor Dev_{U} and from the server managing the WSN network. It is used at the application level in the communications between the Dev_{U} sensor and the server, or even the final user.

Further, each gateway is identified by an identifier and is equipped with a security key at the link level. This security key is a secrete key insofar as it is only known from the gateway and the sensors of the sub-network connected thereto. In the following, LinSK_{A} will designate the security key of the gateway having Gat_{A} as an identifier. In other words, the security key LinSK_{A} ensures the security of the communications (confidentiality, integrity and authentication) at the link level inside the sub-network A.

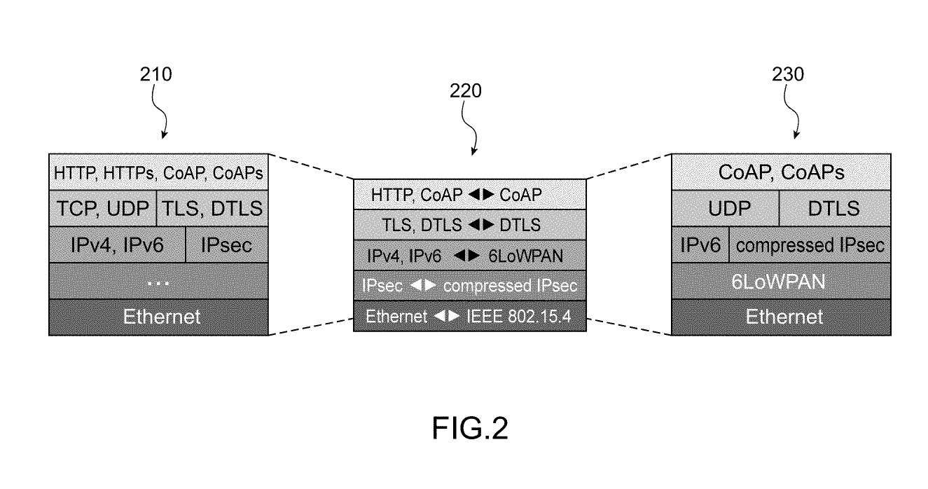

FIG. 2 schematically represents the different protocol layers intervening in a communication between a user and a sensor in the situation of FIG. 1.

210 designates the protocol stack intervening in the Internet domain (for example at the server), 220 designates the protocol stack intervening at the gateway and 230 designates the protocol stack intervening at the WSN network (for example at the mobile sensor).

It has been assumed here that the transmission in the Internet domain between the server and the gateway was made by an Ethernet link (PHY and MAC layer) and that the transmission in the WSN network was made according to the protocol IEEE 802.15.4 (PHY and MAC layers). The transmission at the network level is made according to the protocol IPv4 or IPv6 in the Internet field and according to the protocol IPv6/6LoWPAN on the side of the WSN network. The gateway ensures protocol conversion up to the network level and is transparent to the upper protocol layers.

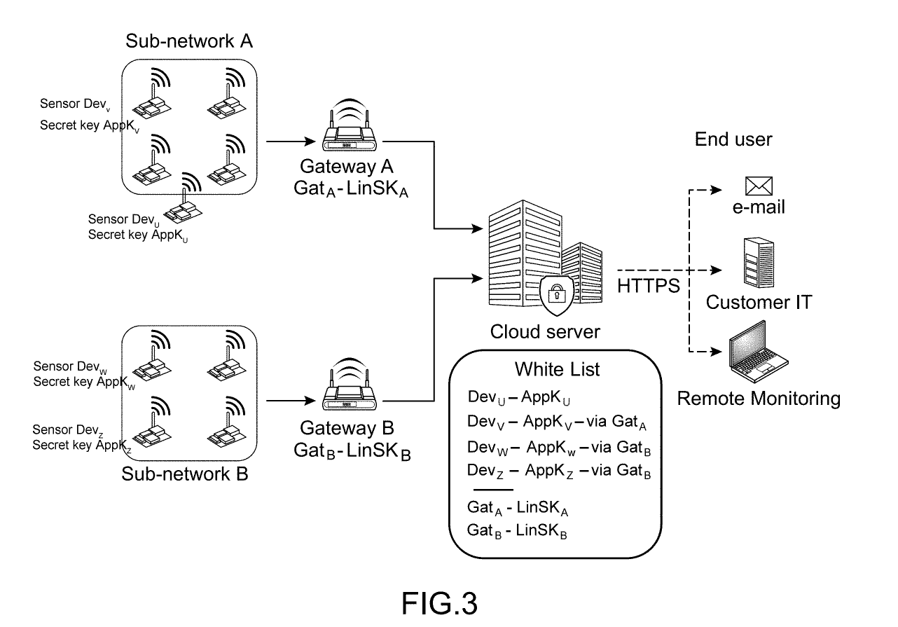

In FIG. 3, the distribution of secrete keys is represented in an end-to-end secured communication method according to one embodiment of the invention.

The sensor Dev_{V} of the sub-network A is equipped with the secrete key AppK_{V}. Further, the sensor Dev_{U} attempting to join the sub-network A is equipped with the secrete key AppK_{U}.

The sensors Dev_{W} and Dev_{Z} of the sub-network B are respectively equipped with the secrete keys AppK_{W} and AppK_{Z}.

The gateways Gat_{A} and Gat_{B} (or equivalently the sub-networks A and B) are respectively equipped with the security keys LinSK_{A} and LinSK_{B}.

The cloud server, managing the WSN network, has a white list of couples of identifiers of permitted devices and their corresponding secrete keys. In the case illustrated, this white list comprises the identifiers of the gateways (Gat_{A},Gat_{B}) respectively associated with their respective security keys (LinSK_{A},LinSK_{B}) and, for each gateway (or equivalently for each sub-network (A, B)), the identifiers of the sensors of the sub-network in question associated with their respective security keys. It will be actually noted that the input of the white list related to a sensor (for example Dev_{V}) of a sub-network corresponds to a triplet consisting of the identifier of this sensor, its security key (AppK_{V}) and the identifier of the gateway (Gat_{A}) of the sub-network to which it belongs. In other words, a communication between the sensor Dev_{V} and the server will be permitted and secured with the AppK_{V} key only insofar as it will be established via the gateway of the sub-network in which the sensor is recorded. In the case where the sensor is a mobile sensor, only the couple of the identifier (Dev_{U}) and its security key AppK_{U}) is stored in the white list of the server.

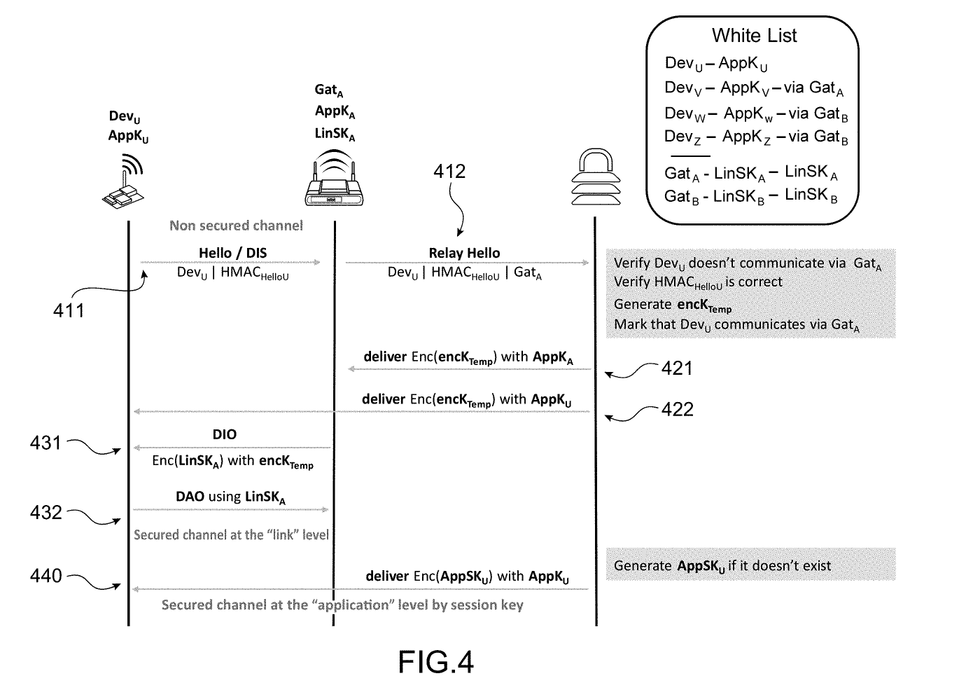

FIG. 4 schematically represents a process for securely associating a sensor with a sub-network, within the scope of an embodiment of the invention.

It is assumed that a mobile sensor (for example Dev_{U} in FIG. 3) wishes to join a secured sub-network.

The detail of the association process has been represented in FIG. 4 in the case where the WSN network is in accordance with the ZigBee standard. However, it is clear to those skilled in the art that this association process is equivalently applicable to a 6LoWPAN network or a LoRaWAN network.

In a first phase, the mobile sensor Dev_{U} takes from the server a temporary key enabling it to securely communicate with the gateway of the sub-network it wishes to join.

More precisely, the mobile sensor Dev_{U} transmits in 411 an association request (“Hello” message) to the gateway of the sub-network, via an unsecured channel.

This message, transmitted at the application layer (APS in the case of the ZigBee protocol), comprises a payload containing at least the identifier of the mobile sensor, a nonce generated by the latter and a signature by means of its security key (AppK_{U}). The signature can for example be an authentication code of a cryptographic footprint HMAC (keyed-Hash Message Authentication Code). Thus, the payload of the association request is given by:

request_{APS-PLD}=Dev_{U}|DevNonce|HMAC(AppK_{U},Dev_{U}|DevNonce) (1)

where HMAC(AppK_{U},Dev_{U}|DevNonce) represents the signature of Dev_{U}|DevNonce by means of the security key, AppK_{U}. In a simplified embodiment, the nonce can be omitted and therefore the association request boils down to request_{APS-PLD}=Dev_{U}|HMAC (AppK_{U},Dev_{U}).

In step 412, the gateway relays the association request to the server managing the network by adding its gateway identifier, Gat_{A}. The payload request_{APS-PLD} is on the other hand transparently relayed by the gateway given that it is located at the applicative level. The message relayed by the gateway to the server can be protected by a TLS encryption.

Upon receiving the message thus relayed, the integrity and authenticity of the message are verified by the server by means of the signature (H MAC). More precisely, the server calculates the signature of Dev_{U}|DevNonce from the security key AppK_{U} stored in the list and compares it with the signature contained in the request_{Aps pa}). The server further verifies that the sensor Dev_{U} does request to join the sub-network A, from the identifier of the gateway Gat_{A}, appended to the message relayed.

Then, the server generates a temporary encryption key, marked EncKₜₑₘₚ, for securing the communication between the sensor and the gateway. This temporary key is transmitted to the gateway Gat_{A} on the one hand and, to the sensor Dev_{U} on the other hand. More precisely, the server encrypts the temporary key EncKₜₑₘₚ by means of the security key of the gateway, AppK_{A} (contained in the white list of the server), and transmits it in 421 to the gateway in a first message, key temp^{Gat}^{_{A}}. Likewise, the server encrypts the temporary key EncKₙᵢₚ by means of the security key of the sensor, AppK_{U}, (also contained in the white list of the server) and transmits it in 422 to the sensor Dev_{U}, in a second message key-temp^{Dev}^{_{U}}. The messages keytemp^{Gat}^{_{A}} and key temp^{Dev}^{_{U}} are transmitted at the application layer (APS layer in the case of ZigBee).

Preferably, the server adds to the temporary key EncKₜₑₘₚ contained in the messages key temp^{Gat}^{_{A}} and key temp^{Dev}^{_{U}}, the nonce DevNonce previously received in the association request of the sensor, to avoid replay attacks, as well as the identifiers of the gateway Gat_{A} and of the sensor Dev_{U}. In this case, the payload of the first and second messages can be expressed as follows:

key-temp_{APS-PLD}^{Gat}^{_{A}}=Encrypt(AppK_{A},Gat_{A}|Dev_{U}|DevNonce|EncKₜₑₘₚ) (2-1)

and

key-temp_{APS-PLD}^{Gat}^{_{U}}=Encrypt(AppK_{U},Gat_{A}|Dev_{U}|DevNonce|EncKₜₑₘₚ) (2-2)

where Encrypt (AppK_{A}, X) and Encrypt (AppK_{U}, X) respectively represent the X encryption by the security key of the gateway, AppK_{A}, and the security key of the sensor, AppK_{U} and X=Gat_{A}|Dev_{U}|DevNonce|EncKₜₑₘₚ designates the concatenation of data Gat_{A}, Dev_{U}, DevNonce and EncKₜₑₘₚ.

Optionally, the server can add to the payload (key-temp_{APS-PLD}^{Gat}^{_{A}}, key-temp_{APS-PLD}^{Dev}^{_{U}}) a signature enabling it to ensure its integrity, if the communication protocol does not intrinsically ensure it on its own. For example, this signature could be obtained as an HMAC code, of a MAC code (Message Authentication Code) or of a MIC code (Message Integrity Code). In the case of an HMAC code, the payloads of the first and second messages can be written as follows:

key-temp_{APS-PLD}^{Gat}^{_{A}}=Encrypt(AppK_{A},X)|HMAC(AppK_{A},X) (3-1)

key-temp_{APS-PLD}^{Dev}^{_{U}}=Encrypt(AppK_{U},X)|HMAC(AppK_{U}|X) (3-2).

Upon receptions, the gateway Gat_{A} and the sensor Dev_{U} decrypt the content of the first and of the second message by means of their respective security keys, and then verify optionally the integrity of the payload by means of the signature.

In this stage, the gateway Gat_{A} and the sensor Dev_{U} have a shared common secrete key, EncKₜₑₘₚ (typically of 128 bits), enabling them to establish a secured channel between them, at the link level.

In a second phase, the gateway transmits to the mobile sensor the security key of the sub-network, this transmission being secured by the temporary encryption key, EncKₜₑₘₚ, provided beforehand by the server to the gateway and to the sensor in question.

More precisely, in step 431, the gateway Gat_{A} uses the temporary key EncKₜₑₘₚ to transmit to the sensor Dev_{U}, the security key of the sub-network, LinSK_{A}. As previously indicated, this key is for protecting the transmissions within the sub-network A, at the link level.

More precisely, the gateway Gat_{A} transmits the encrypted information Encrypt(EncKₜₑₘₚ,LinSK_{A}) to the sensor Dev_{U}, either in the payload of a message at the application level, or in the payload of a message at the network level, such that it can be routed in the sub-network (optionally in several “hops”) to the sensor. The message at the application level is for example in the form of a DIO (DODAG Information Object where DODAG means Destination Oriented Direct Acyclic Graph) control message of the RPL routing protocol. It is reminded that RPL specifies a routing protocol suitable for IPv6 communication needs above the low power lossy networks.

As above, the gateway can add to the encrypted information, Encrypt(EncKₜₑₘₚ,LinSK_{A}), the DevNonce nonce as well as the identifiers of the gateway Gat_{A} and the sensor Dev_{U}.

For example, if the transmission is performed at the applicative level, the payload can be expressed as:

key_{APS-PLD}^{Gat}^{_{A}}=Encrypt(EncKₜₑₘₚ,Gat_{A}|Dev_{U}|DevNonce|LinSK_{A}) (4)

with the same notation conventions as previously. The inclusion of Dev_{U} and DevNonce in the payload enables the process to be traced, in other words makes it possible to indicate that the sub-network key transmitted in step 431 actually follows the association request initiated by the sensor, thus avoiding any ambiguity in the case where several sensors would simultaneously join the sub-network.

Optionally, the gateway Gat_{A} can add to the payload a signature (H MAC, MAC, MIC). Thus, when the signature is an HMAC signature, the payload becomes:

key_{APS-PLD}^{Gat}^{_{A}}=Encrypt(EncKₜₑₘₚ,Y)|HMAC(EncKₜₑₘₚ,Y) (5)

with Y=Gat_{A}|Dev_{U}|DevNonce|LinSK_{A}.

According to one alternative, instead of transmitting a single sub-network key LinSK_{A}, the gateway could transmit two distinct keys LinSK_{A}¹ and LinSK_{A}², one to encrypt messages (at the link level) and the other to sign them.

In any cases, the sensor Dev_{U} decrypts the payload key_{APS-PLD}^{Gat}^{_{A}} of the message by means of the temporary key EncKₜₑₘₚ previously received, and then optionally verifies the integrity of the payload by means of the signature. If the message is of integrity, the security key of the sub-network, LinSK_{A}, is stored in the random access memory of the sensor.

The sensor Dev_{U} then transmits in 432 an acknowledgment message to the gateway, for example in the form of a DAO (Destination Advertisement Object) control message. This acknowledgment message is encrypted by means of the security key of the sub-network LinSK_{A}.

When the sensor moves from one sub-network to the other, the old sub-network key stored in the random access memory of the sensor is replaced by the new key transmitted by the gateway of the sub-network it has just joined.

The process described above is repeated for each new sensor which joins the sub-network.

If the sensor has not yet a session key to communicate data at the applicative level, the cloud server sends it one in 440 that it will maintain in mobility. This key, noted AppSK_{U} in FIG. 4, is transmitted to the sensor in the same way as the temporary key, EncKₜₑₘₚ. The sensor then stores it in its random access memory and the cloud server maintains it in its white list for future exchanges.

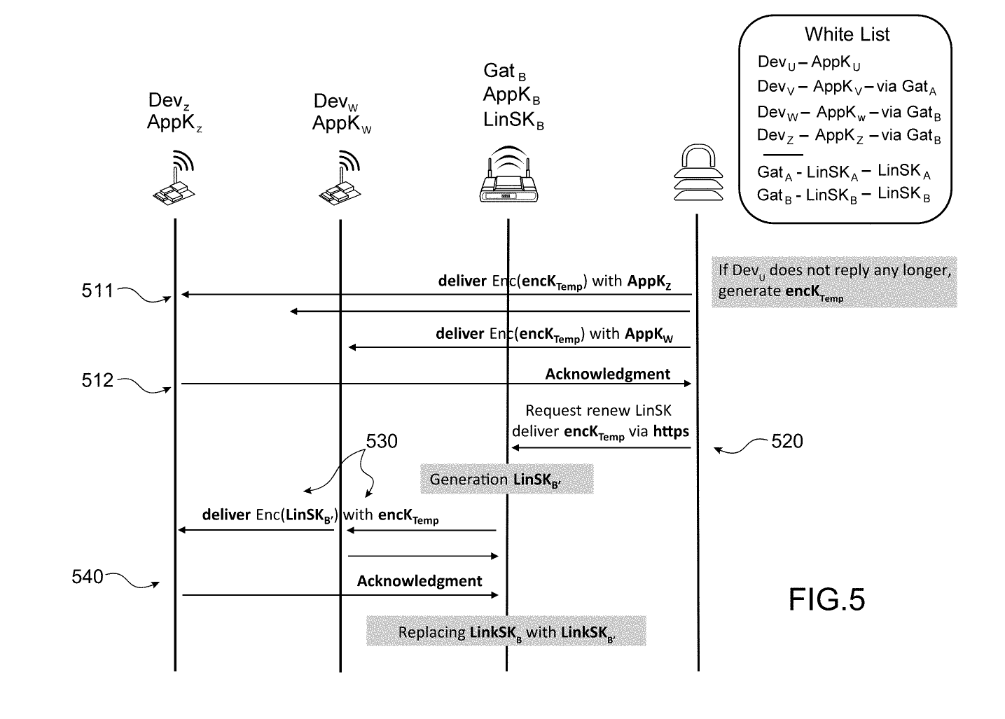

FIG. 5 schematically represents a process for renewing/revoking a security key in a sub-network in an end-to-end secured communication method according to one embodiment of the invention.

This process of renewing the security key of the sub-network is initiated at regular intervals or upon the occurrence of an event depending on the security degree required. For example, it could be initiated each time a sensor does not reply to the server request any longer, regardless of whether this has left the sub-network, or its battery is exhausted.

The purpose of renewing the security key of the sub-network is to cope with an attack which would consist in reading this security key in the memory of one of the sensors.

In the example illustrated, it is assumed that the server has detected that the mobile sensor Dev_{U} does not reply to its requests any longer. Therefore, it decides to renew the key of the sub-network B with which it was associated. After renewing this key, the sensor Dev_{U} will be de facto excluded from the sub-network insofar as it will not have the new key.

In step 511, the server transmits to each sensor of the sub-network B (only two sensors Dev_{Z} and Dev_{W} of this sub-network have been represented by way of example), a new temporary key EncKₜₑₘₚ′.

This new temporary key is transmitted in an encrypted form using the security key of the sensor (AppK_{W}, AppK_{Z}) or its session key (AppSK_{W},AppSK_{Z}).

For example, the server transmits to the sensor Dev_{W} a message at the applicative level, temp_key^{B}, containing the following payload:

temp_key_{APS-PLD}^{B}=Encrypt(AppK_{W},Gat_{B}|Dev_{W}|AppNonce|EncKₜₑₘₚ′) (6-1)

or, when the session key is used:

temp_key_{APS-PLD}^{B}=Encrypt(AppSK_{W},Gat_{B}|Dev_{W}|AppNonce|EncKₜₑₘₚ′) (6-2)

with the same notation conventions as previously. In particular, X′=Gat_{B}|Dev_{W}|AppNonce|EncKₜₑₘₚ′ represents the concatenation of the identifier of the gateway Gat_{B}, of the identifier of the destination sensor, Dev_{W}, of a nonce generated by the server, AppNonce, and of the temporary key EncKₜₑₘₚ′. The nonce enables the exchange to be traced by being subsequently resumed in the acknowledgment message of the Dev_{W} sensor.

Preferably, the server adds to the payload a signature (HMAC, MAC, MIC). Thus, when the signature is an HMAC signature, the payload becomes:

temp_key_{APS-PLD}^{B}=Encrypt(AppK_{W},X′)|HMAC(AppK_{W},X′) (7-1)

or, when the session key is used:

temp_key_{APS-PLD}^{B}=Encrypt(AppSK_{W},X′)|HMAC(AppSK_{W},X′) (7-2).

Upon receiving the message, the sensor decrypts the payload by means of its security key AppK_{W} or its session key AppSK_{W} and verifies it for the integrity by means of the signature. It extracts the temporary key EncKₜₑₘₚ′ and the nonce AppNonce from the payload.

In step 512, each sensor of the sub-network B having received the temporary key EncKₜₑₘₚ′ transmits an acknowledgment message to the server by incorporating its identifier and the previously received nonce AppNonce therein. Thus, the acknowledgment message ack_new_key^{W} sent back by the sensor contains the payload:

ack_temp_key_{APS-PLD}^{W}=Encrypt(AppK_{W},ACK|Gat_{B}|Dev_{W}|AppNonce) (8-1)

or, when the session key is used:

ack_temp_key_{APS-PLD}^{W}=Encrypt(AppSK_{W},ACK|Gat_{B}|Dev_{W}|AppNonce) (8-2).

Once again, the sensor can add to the payload a signature (HMAC, MAC, MIC) to allow a verification for the integrity of the acknowledgment message by the server.

Once the server has received all the acknowledgment messages, it sends in 520 to the gateway Gat_{B} a request for renewing the security key of the sub-network B, renew_key^{B}. This request contains the temporary key EncKₜₑₘₚ′ and can be transmitted via the secured protocol https or even by encrypting the payload with the key AppK_{B}.

The gateway Gat_{B} gateway thereby generates a new security key of the sub-network, LinSK_{B}′ and broadcasts it in 530 to the sub-network sensors as a message encrypted by the temporary key EncKₜₑₘₚ′, broadcast_key^{B}. The message can be transmitted at the link, network or application level.

The payload of the message broadcast by the gateway Gat_{B}, broadcast_key^{B}, can be expressed as:

broadcast_key^{B}=Encrypt(EncKₜₑₘₚ′,Gat_{B}|LinSK_{B}′) (9)

Optionally, a nonce can be generated by the gateway and added to the encryption argument for acknowledgment needs. Further, the payload can still be signed, so as to be capable of verifying its integrity at the sensors, and in particular that the new key LinSK_{B}′ is proper.

Propagating the message broadcast_key^{B} in the sub-network is made by hops from one sensor to the other.

Once each sensor has received the broadcast_key^{B} message, it decrypts the content thereof and marks of the value of the new key. Then, it sends back in 540 an acknowledgment message to the gateway Gat_{B}, and then replaces its sub-network security key stored in a random access memory.

Once the gateway Gat_{B} has received all the acknowledgments, the communications between the sensors of the sub-network B and the server (or the final user) can resume.

In practice, there will be always sensors which will not reply. It can be considered to broadcast again the message broadcast_key^{B} in case where this message or the corresponding acknowledgment would be lost. However, if the sensor still does not reply after a fixed number of demands, the sub-network security key is updated by all the sub-network sensors that have replied by acknowledgment. For the other ones, a secured association process could be initiated when they are ready to join a sub-network.

In the description both of the association process and renewing the sub-network security key, it has been assumed that the security key of the gateway and the security key of the mobile sensor could be used not only for encryption of messages but also to their signature. Alternatively, the gateway and/or the mobile sensor could each have a security key (for encryption) and a key for signature. The security keys and signature keys are thereby stored in the white list of the server in connection with the identifiers of the corresponding devices (gateway, mobile sensor).

1. An end-to-end secured communication method between a mobile sensor and a user, the mobile sensor moving within a WSN network, said WSN network comprising at least one sub-network connected to the Internet with a gateway, said gateway being connected via the Internet to a server managing said WSN network, wherein:
the mobile sensor has an identifier (Dev_{U}) and its own security key (AppK_{U}), and forms an association request by concatenating the identifier of the mobile sensor and a signature of said identifier by the security key of the mobile sensor;
said mobile sensor transmits an association request to the gateway, this relays it to the server;
the server has a white list containing the identifiers of the sensors permitted to be connected via said gateway, associated with their respective security keys, as well as the identifier of said gateway (Gat_{A}) associated with its security key, the server verifying the authenticity and the integrity of the association request of the mobile sensor with said signature, and in case of success:
the server generates a temporary encryption key (EncKₜₑₘₚ) and communicates it in an encrypted form to the gateway as well as to the sensor;
the gateway transmits to the mobile sensor, a sub-network security key for securing, at the link level, the transmissions within the sub-network, said sub-network security key being transmitted to the mobile sensor in an encrypted form by the temporary encryption key;
said mobile sensor transmits to the gateway an acknowledgment message, encrypted with said sub-network security key.

2. The end-to-end secured communication method according to claim 1, wherein the mobile sensor forms the association request by further generating a nonce (DevNonce) and concatenating the identifier of the mobile sensor, the nonce thus generated and a signature of the identifier and of the nonce thus concatenated, by the security key of the mobile sensor.

3. The end-to-end secured communication method according to claim 2, wherein, upon reception of the association request, the server, after it has checked the request integrity, encrypts the temporary encryption key (EncKₜₑₘₚ) with the security key of the gateway (AppK_{A}) to generate a first message (keytemp^{Gat}^{_{A}}) and with the security key of the mobile sensor to generate a second message (key temp^{Dev}^{_{U}}), the first and second messages being respectively transmitted to the gateway and to the mobile sensor at the application layer.

4. The end-to-end secured communication method according to claim 3, wherein the first message (key temp^{Gat}^{_{A}}) is obtained by concatenating the identifier of the gateway (Gat_{A}), the identifier of the mobile sensor (Dev_{U}), the nonce (DevNonce) and said temporary encryption key (EncKₜₑₘₚ) to form a first set of concatenated information, said first set of concatenated information being encrypted with the security key of the gateway (AppK_{A}).

5. The end-to-end secured communication method according to claim 4, wherein the first set of concatenated information is signed with a signature key of the gateway and wherein the signature is concatenated to the first set of concatenated information previously encrypted with the security key of the gateway (AppK_{A}).

6. The end-to-end secured communication method according to claim 5, wherein the signature key of the gateway is identical to the security key of the gateway.

7. The end-to-end secured communication method according to claim 3, wherein the second message (key tempp^{Dev}^{_{U}}) is obtained by concatenating the identifier of the gateway (Gat_{A}), the identifier of the mobile sensor (Dev_{U}), the nonce (DevNonce) and said temporary encryption key (EncKₜₑₘₚ) to form a second set of concatenated information, said second set of concatenated information being encrypted with the security key of the mobile sensor AppK_{U}).

8. The end-to-end secured communication method according to claim 7, wherein the second set of concatenated information is signed with a signature key of the mobile sensor and wherein the signature thus obtained is concatenated to the second set of concatenated information previously encrypted with the security key of the mobile sensor AppK_{U}).

9. The end-to-end secured communication method according to claim 8, wherein the signature key of the mobile sensor is identical to the security key of the mobile sensor.

10. The end-to-end secured communication method according to claim 3, wherein the gateway transmits to the sensor a third message containing the sub-network key (LinSK_{A}) encrypted by the temporary encryption key, the third message being transmitted at the application level or at the network level.

11. The end-to-end secured communication method according to claim 10, wherein the third message contains a concatenation of the identifier of the gateway (Gat_{A}), of the identifier of the mobile sensor (Dev_{U}), of the nonce and of the sub-network key.

12. The end-to-end secured communication method according to claim 1, wherein, when the server detects that a sensor of the sub-network does not reply any longer to the requests of the server, or at regular time intervals, the server generates a new temporary encryption key (EncKₜₑₘₚ′), and transmits it to each sensor (Dev_{Z},Dev_{W}) belonging to the sub-network in an encrypted form by the security key of this sensor (AppK_{W},AppK_{Z}) or a session key (AppSK_{W},AppSK_{Z}) previously exchanged between the gateway and this sensor.

13. The end-to-end secured communication method according to claim 12, wherein the server transmits to the gateway a renew request for the sub-network key to the gateway (renew_key^{B}), said renew request containing the new temporary encryption key (EncKₜₑₘₚ′), in an encrypted form by the security key of the gateway (Gat_{B}).

14. The end-to-end secured communication method according to claim 13, wherein, when the gateway has received the renew request from the server, this generates a new sub-network key (LinSK_{B}′) and broadcasts it to the sub-network sensor in the form of an encrypted message broadcast_key^{B}) by the new temporary encryption key (EncKₜₑₘₚ′).
